(19) United States
(12) Patent Application Publication
(10) Pub. No.: US 2013/0002559 A1
(43) Pub. Date: Jan. 3, 2013

(54) DESKTOP COMPUTER USER INTERFACE

(76) Inventor: Nachum VARDI, Mevaseret Tzion (IL)

(21) Appl. No.: 13/366,322

(22) Filed: Feb. 5, 2012

Related U.S. Application Data
(60) Provisional application No. 61/504,210, filed on Jul. 3, 2011.

(51) Int. Cl. G06F 3/02

(52) U.S. Cl. 345/168

(57) ABSTRACT

A user interface, comprising: video glasses (10), for being used as a display of a desktop computer; built-in earphones (60), connected to a frame of the video glasses, for being used as an output facility of the computer; microphone (24) embedded in a frame of the video glasses (10), for being used as an input facility to the computer; a keyboard substitute for the computer or cellular telephone, the keyboard substitute comprising: (a) a virtual keyboard (20), projected on a display of the video glasses (10); (b) at least one glove (12) and sensors (14) for indicating the state and position of each of the fingers of the at least one glove (12), with reference to the image of a keyboard; thereby providing a user interface in a form of video glasses for the computer.

The current application claims the benefit of U.S. Provisional Patent Application No. 61/504,210, filed 3 Jul. 2010, incorporated herein by reference.

### FIELD OF THE INVENTION

The present invention relates to the field of user interfaces. More particularly, the invention relates to a user interface for a desktop computer.

### BACKGROUND OF THE INVENTION

The term user interface refers to facilities and functionality for allowing interaction between a human user and a computerized machine. The purpose of a user interface is to allow a human user to monitor and/or control the computerized machine. For these purposes, a user interface may include inputting facilities such as keyboard and mouse, and/or to display the output from the computer, such as video signals and audio signals.

Video glasses (also known as data glasses or visor) are a recently developing output facility. It comprises two displays, embedded in a glasses form device. Thus, a user that wears video glasses can watch a video display, such as a movie. Video glasses are common as an output device for video games and military simulators.

When a human user wears video glasses, there is an obstacle to using a keyboard with hands, as the glasses block the vision therethrough. Due to this reason, video glasses have not been implemented so far as an output device for desktop computers.

It is an object of the present invention to provide a solution to the above-mentioned and other problems of the prior art.

Other objects and advantages of the invention will become apparent as the description proceeds.

### SUMMARY OF THE INVENTION

In order to facilitate the reading to follow, the following terms are defined:

The term desktop computer or shortly computer refers herein to any computer that employs a user interface comprising an output facility such as a display and input facility in the form of an alphanumeric keyboard, whether real or virtual.

A user interface, comprising:
video glasses (10), for being used as a display of a desktop computer;
built-in earphones (60), connected to a frame of the video glasses, for being used as an output facility of the computer;
microphone (24) embedded in a frame of the video glasses (10), for being used as an input facility to the computer;
a keyboard substitute for the computer or cellular telephone, the keyboard substitute comprising:
   a virtual keyboard (20), projected on a display of the video glasses (10);
   at least one glove (12) and sensor (14) for indicating the state and position of each of the fingers of the at least one glove (12), with reference to the image of a keyboard;
      thereby providing a user interface in the form of video glasses for the computer.

According to one embodiment of the invention, the user interface further comprises a mouse in wired or wireless communication with the video glasses.

According to one embodiment of the invention, the video glasses are a separate entity from the computer, and communicate with the computer via wired or wireless communication.

According to another embodiment of the invention, the computer is embedded in the video glasses.

According to yet another embodiment of the invention, the computer is embedded in a device connected to the video glasses via a USB connection.

The user interface may further comprise a connection box (not illustrated), for connecting between the computer and the video glasses, thereby allowing placing a substantial part of the circuitry of the video glasses in the connection box.

The user interface may further comprise circuitry and/or computer code for analyzing human speech and translating thereof to computer instructions.

According to one embodiment of the invention, the video glasses enable to see therethrough, in an optical manner, a real-world view (i.e., the glasses are half-opaque in order to allow a user to see the real world view through the glasses).

According to another embodiment of the invention, the video glasses enable to see therethrough, in a digital manner, a real-world view (i.e., a camera on the glasses allows to take a video stream and display it on the screens of the glasses, or to superimpose it in the computer display).

According to one embodiment of the invention, the video glasses are stereoscopic (i.e., a different image is displayed to each eye), thereby allowing presenting 3D images.

The user interface may further comprise a projector (22), for projecting an image of the glasses on a flat surface in front of the user.

The video glasses may further comprise a USB connector and circuitry, for allowing connecting additional peripherals to the computer via the video glasses.

The video glasses may further comprise a memory slot (30) and circuitry, for allowing connecting a memory (28) to the computer via video glasses.

The video glasses may further comprise a camera (whether stills or video), for inputting video signals.

The video glasses may further comprise a cellular telephone circuitry, embedded in the video glasses, thereby allowing using the video glasses as cellular telephone.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a user interface facility for a desktop computer, according to one embodiment of the invention.

FIG. 2 schematically illustrates peripheral devices that can be connected to the video glasses, according to embodiments of the present invention.

FIG. 3 schematically illustrates further peripheral devices that can be connected to the video glasses, according to one embodiment of the invention.

FIG. 4 schematically illustrates a usage of video glasses as a part of a cellular telephone, according to one embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

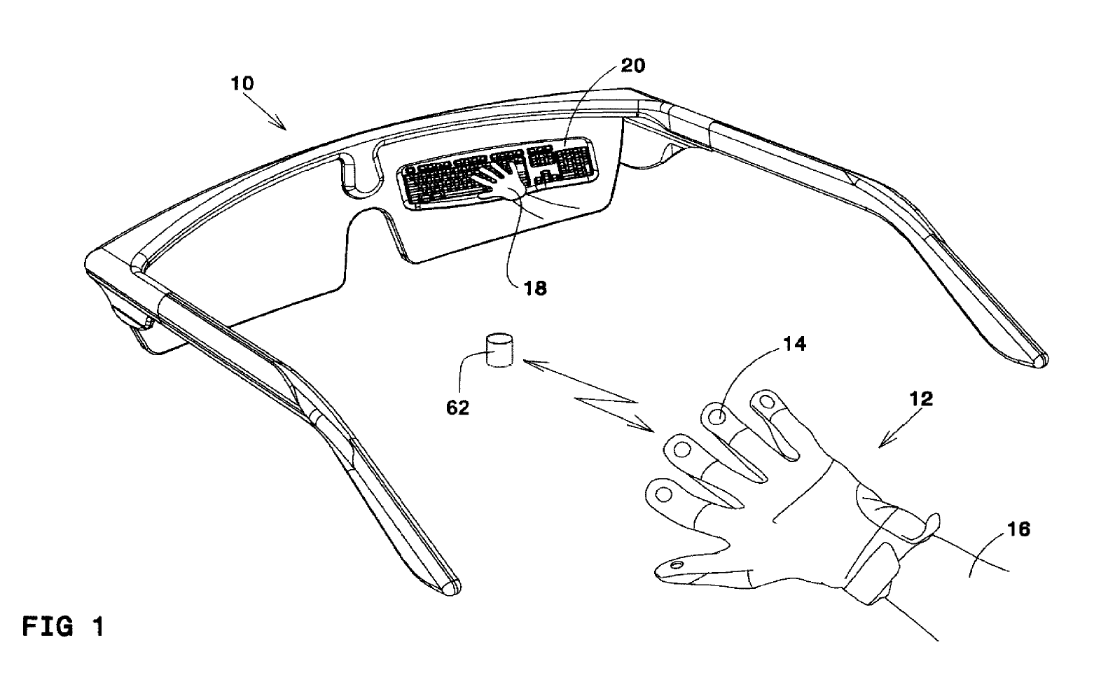

FIG. 1 schematically illustrates a user interface facility for a desktop computer, according to one embodiment of the invention.

According to this embodiment of the invention, the display (screen) of the desktop computer is replaced by video glasses 10.

As per the keyboard, as a user may not see the real world through video glasses, a “real” keyboard (i.e., tangible keyboard) cannot be useful, unless the glasses are designed to show the real world therethrough.

As a substitute to a real keyboard, video glasses 10 display a virtual keyboard 20, and at least one virtual glove 18. In addition, the user wears a real glove 12 on his palm, which comprises sensors 14 on each of the fingers thereof, for sensing (a) the state of each of the fingers of the glove, and (b) the absolute and/or relative position of each of the fingers thereof with reference to an imaginary keyboard (not illustrated).

As the user moves glove 12 with reference to the imaginary keyboard, the virtual glove 18 imitates this movement. As a user “hits” by the finger of the glove (e.g., performs a sudden movement downwards), the computer interprets this event as hitting the key of the virtual keyboard 20 at which the virtual finger of virtual glove 18 points. The display of the virtual glove may animate the key hit, e.g., by a blink.

The imaginary keyboard may be embodied as a landmark device 62 placed in front of the user. The landmark device and the glove comprise circuitry for indicating the location of each of the sensors on the glove with reference to the landmark device.

It should be noted that if the landmark device 62 would have been a part of the video glasses, the mechanism for indicating the location and state of each of the sensors on the fingers of the glove would have been more complicated, as the video glasses are not stationary. A landmark device placed in a stationary location simplifies the mechanism.

Although in the figures only one glove is displayed, according to a preferred embodiment of the invention, two gloves are used, as typing on a keyboard is usually effected by two hands.

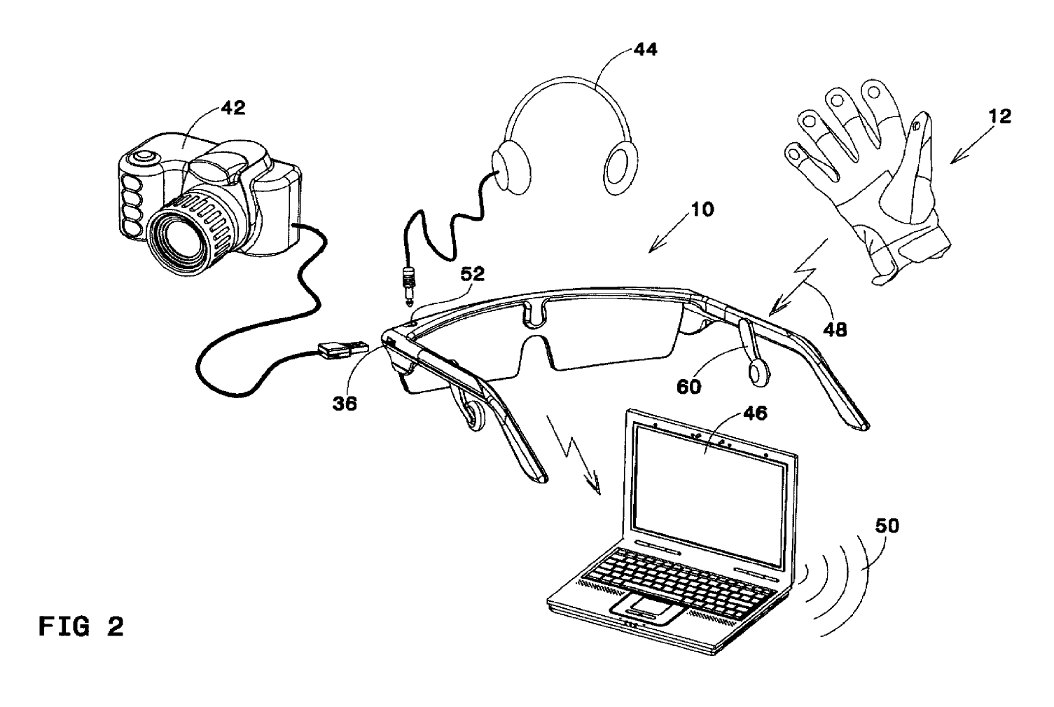

FIG. 2 schematically illustrates peripheral devices that can be connected to the video glasses, according to embodiments of the present invention.

The video glasses may comprise built-in earphones 60, connected to the ear bars of the video glasses.

Additionally or alternatively, the video glasses may comprise external earphones 44 connected to the video glasses through a corresponding connector 52.

The video glasses may also comprise a USB (Universal Serial Bus) connector 36, through which a camera 42 and the like can be connected.

Glove 12 can communicate with the video glasses 10 by Bluetooth communication 48.

Video glasses 10 can be connected to a wireless network 50, to a laptop computer 46, and so on.

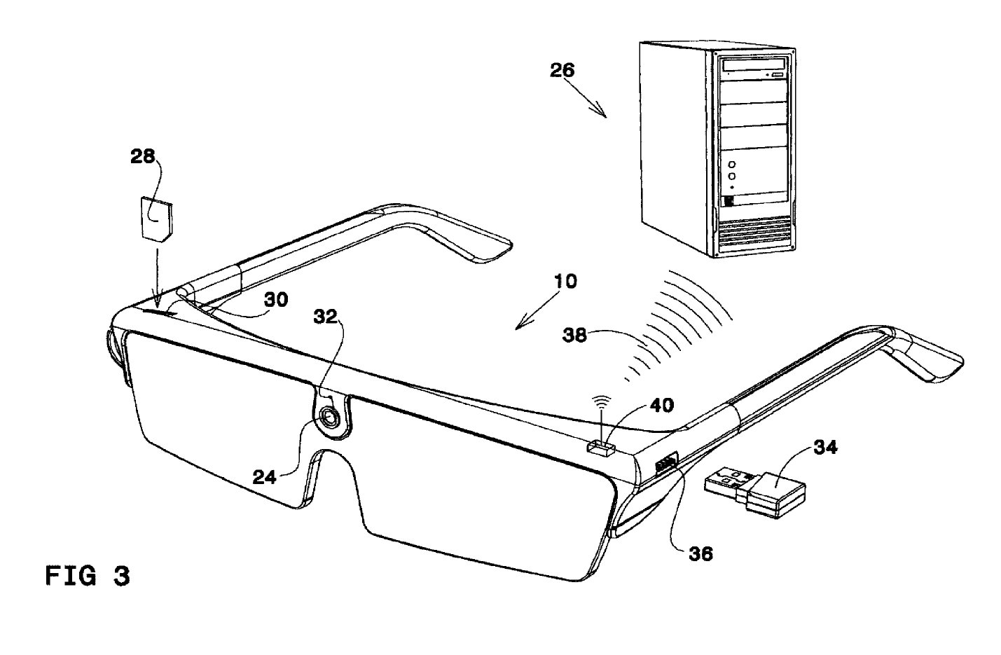

FIG. 3 schematically illustrates further peripheral devices that can be connected to the video glasses, according to one embodiment of the invention.

A slot 30 on the frame of video glasses 10 may be used for connecting external memory to the video glasses, and also therefrom to the desktop computer 26 thereof.

An Internet camera 32 and built-in microphone 24 are connected to the front of the video glasses, thereby allowing transmitting multimedia information sensed by the individual wearing the video glasses.

FIG. 3 also schematically illustrates some configurations of a desktop computer system that employs the video glasses.

According to a first configuration, the video glasses are a user interface output facility of desktop computer 26. For this purpose, the video glasses are connected with desktop computer 26 via RF (Radio Frequency) signal 38, such as Bluetooth communication. Bluetooth is an open specification for short-range wireless communication between various types of communication devices, such as cellular telephones, pagers, hand-held computers, and personal computers.

According to a second configuration, the desktop computer is device 34, which connects to the video glasses via USB connector 36.

According to a third configuration (not illustrated), the desktop computer is embedded in the video glasses. Of course, such configuration requires ultimate minimization of the components thereof. The ear bars of the video glasses may be used as housing for batteries.

According to a fourth configuration (not illustrated), the video glasses 10 are connected to desktop computer 26 by wired communication means.

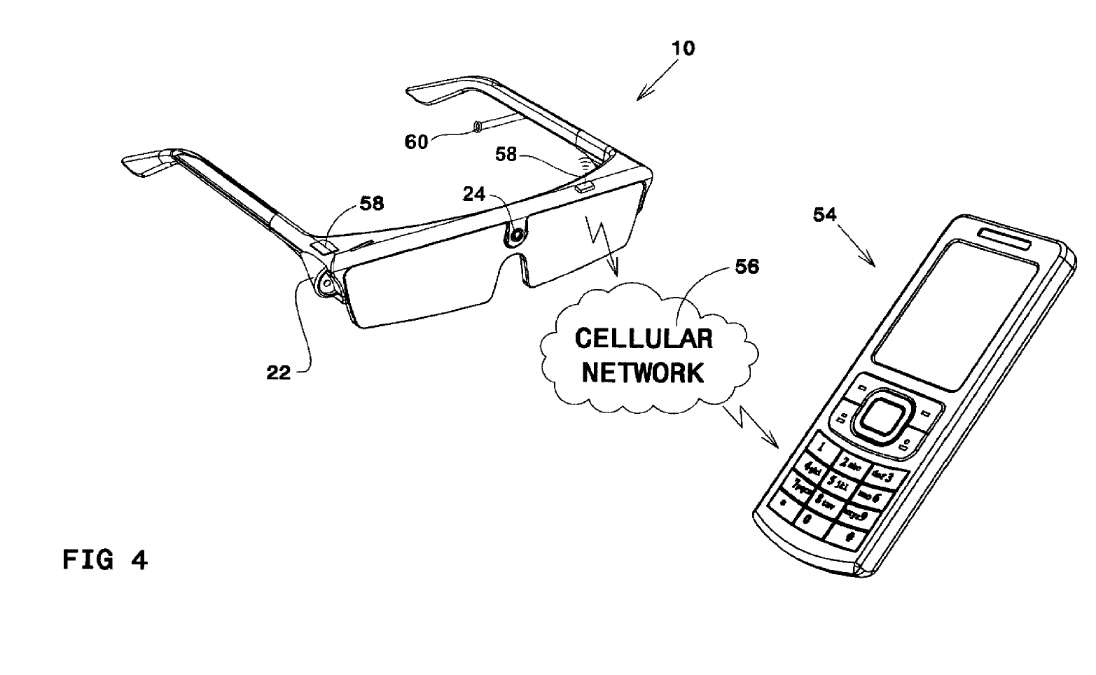

FIG. 4 schematically illustrates a usage of video glasses as a part of a cellular telephone, according to one embodiment of the invention.

A cellular telephone circuitry (not illustrated) is embedded in the frame of video glasses 10. The cellular telephone circuitry uses the display of video glasses 10, built-in microphone (24) and built-in earphones (60). Thus, a user wearing video glasses 10 can engage in a cellular telephone conversation with a user of cellular telephone 54.

The cellular telephone embedded in video glasses 10 communicates with cellular telephone 54 via cellular network 56.

Actually, cellular telephones are presently designed to perform operations of desktop computing, and vice versa. As such, there is no point in distinguishing between a cellular telephone that provides only telephone functionality and a cellular telephone that also provides functionality of a desktop computer.

In the figures and/or description herein, the following reference numerals have been mentioned:
numeral 10 denotes video glasses, used as a user interface facility to a computer;
numeral 12 denotes a glove having thereon sensors 14;
numeral 14 denotes a sensor on a finger of glove 12, used for indicating the position (i.e., on which key of a keyboard it points) and state (pressed or not) thereof;
numeral 16 denotes a user's hand;
numeral 18 denotes a virtual glove (or palm) displayed on a display of video glasses 10;
numeral 20 denotes a virtual keyboard displayed on a display of video glasses 10;
numeral 22 denotes a projector, for projecting the content displayed on the display of video glasses 10, on a flat surface;
numeral 24 denotes a microphone embedded in a frame of video glasses 10;
numeral 26 denotes a desktop computer;
numeral 28 denotes a memory card;
numeral 30 denotes a slot and circuitry, through which a memory can be added to a desktop computer connected to or embedded in the video glasses 10;
numeral 32 denotes an Internet camera;
numeral 34 denotes a desktop computer embedded in a chip, such as a smart card;
numeral 36 denotes a USB connector in a frame of video glasses 10;
numeral 38 denotes an RF (Radio Frequency) signal, such as a Bluetooth signal;
numeral 40 denotes an RF transceiver;
numeral 42 denotes a camera;
numeral 44 denotes external earphones connected to video glasses 10 through a corresponding connector 52;
numeral 46 denotes a laptop computer, connected to video glasses 10;
numeral 48 denotes a Bluetooth communication signal;
numeral 50 denotes a wireless network;
numeral 52 denotes an earphones connector;
numeral 54 denotes a cellular telephone;
numeral 56 denotes a cellular network;
numeral 58 denotes a cellular transceiver, embedded in video glasses 10;
numeral 60 denotes built-in earphones; and
numeral 62 denotes a landmark device to be placed in front of a user.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A user interface, comprising:
video glasses (10), for being used as a display of a desktop computer;
built-in earphones (60), connected to a frame of said video glasses, for being used as an output facility of said computer;
microphone (24) embedded in a frame of said video glasses (10), for being used as an input facility to said computer;
a keyboard substitute for said computer or cellular telephone, said keyboard substitute comprising:
a virtual keyboard (20), projected on a display of said video glasses (10);
at least one glove (12) and sensors (14) for indicating the state and position of each of the fingers of said at least one glove (12), with reference to said image of a keyboard;
thereby providing a user interface in a form of video glasses for the computer.

2. A user interface according to claim. 1, further comprising a mouse in wired or wireless communication with said video glasses.

3. A user interface according to claim 1, wherein said video glasses are a separate entity from said computer, and communicating with said computer via wired or wireless communication.

4. A user interface according to claim 1, wherein said computer is embedded in said video glasses.

5. A user interface according to claim 1, wherein said computer is embedded as a device connected to said video glasses via a USB connection.

6. A user interface according to claim 1, further comprising a connection box, for connecting between said computer and said video glasses, thereby allowing placing a substantial part of the circuitry of said video glasses in said connection box.

7. A user interface according to claim 1, further comprising circuitry and/or computer code for analyzing human speech and translating thereof to computer instructions.

8. A user interface according to claim 1, wherein said video glasses enable to see therethrough, in an optical manner, a real-world view.

9. A user interface according to claim 1, wherein said video glasses enable to see therethrough, in a digital manner, a real-world view.

10. A user interface according to claim 1, wherein said video glasses are stereoscopic, thereby allowing presenting 3D images.

11. A user interface according to claim 1, further comprising a projector, for projecting an image of said glasses on a flat surface in front of said user.

12. A user interface according to claim 1, wherein said video glasses further comprise a USB connector and circuitry, for allowing connecting additional peripherals to said computer via said video glasses.

13. A user interface according to claim 1, wherein said video glasses further comprise a slot (30) and circuitry, for allowing connecting a memory (28) to said computer via video glasses.

14. A user interface according to claim 1, further comprising a camera, for inputting video signals.

15. A user interface according to claim 1, further comprising a cellular telephone circuitry, embedded in said video glasses, thereby allowing using said video glasses as a cellular telephone.
